(19) United States
(12) Patent Application Publication
(10) Pub. No.: US 2007/0021866 A1
(43) Pub. Date: Jan. 25, 2007

(54) Dispenser tray for a vending machine

(76) Inventors: Richard G. Coppola, Richmond Heights, MO (US); Ronald A. Hoormann, St. Charles, MO (US); Thomas F. Unsicker, Shrewsbury, MO (US); Steven M. Zychinski, St. Louis, MO (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 11/490,595

(22) Filed: Jul. 21, 2006

Related U.S. Application Data
(63) Continuation of application No. 11/421,935, filed on Jun. 2, 2006.
(60) Provisional application No. 60/701,269, filed on Jul. 21, 2005.

(51) Int. Cl. G06F 17/00

(52) U.S. Cl. 700/231

(57) ABSTRACT

A method of moving an elevator to a product location in a vending machine to receive product from the product location, including the steps of: providing an indicator associated with each product location; providing a sensor associated with the elevator; moving the sensor first to a position near an expected position of one of the indicators; and searching for an actual position of the indicator. An apparatus for performing the method is also disclosed.

### RELATED APPLICATIONS

The present application claims priority to U.S. Provisional Patent Application Ser. Nos. 60/701,269 filed Jul. 21, 2005, the contents of which are incorporated herein by reference, and is a continuation of U.S. patent application Ser. No. 11/421,935, the contents of which are incorporated herein by reference.

### BACKGROUND OF THE INVENTION

In the past, vending machines have been used to dispense beverages. In one common configuration, cans or glass or plastic bottles are stacked in a vertical or offset-vertical columns and dispensed from the bottom of the columns into a holding area below the columns where the customer can retrieve the beverage. Generally, a funnel-type diverter will be used to divert the beverage to the location of the holding area and also to prevent the beverage container from being damaged during the drop. This configuration requires that the column be shorter than the height of the machine so that the beverage can be dropped into the holding area below the column. As a result, storage space that could be used to increase capacity is wasted on the holding area. This is undesirable because in the vending industry it is preferable to have the maximum capacity of product in a machine of a given size in order to maximize sales and maximize the time between product restocking.

Additionally, vending machines incorporating products, typically snacks and candy, have utilized trays having horizontal columns of product placed between each revolution of a helical shaft. The shaft is rotated one revolution, which causes an item near the end of the screw to be forced forward and become disassociated from the helical shaft. Typically, the product will drop from the front of the tray into a holding area that can be accessed by the customer to retrieve the item. The holding area must be lower than the lowest tray so that an item may drop into the holding area. As a result, space associated with the holding area is not used for storing product, thus wasting some usable space. Moreover, the helical shaft is not particularly suited for beverage containers.

Another type of vending machine, such as that shown in U.S. Pat. No. 6,556,889 to Rudick et al., uses an elevator to receive product that is dropped from sloping trays. The product slides down the sloped trays by the force of gravity into the elevator that is moveable to a location adjacent the tray. An actuator located between the lowermost beverage and the elevator selectively allows a beverage to pass into the elevator. The elevator then moves to a second location whereby a conveyor belt in the elevator conveys the beverage to one side of the elevator where it is conveyed into a holding area to the side of the elevator. However, because the vending machine of the '889 patent utilizes sloped shelves, some of the vertical capacity of the vending machine is wasted. Moreover, because product dispensation relies on sloping shelves, jamming of product can occur if the slope is insufficient to allow for simultaneous movement of the column of product (particularly if product spillage occurs causing sticky trays) or of the product is heavy (such as large glass bottles) and applies too much force to the product dispensation actuator.

Therefore, there is a need for a vending machine, particularly a beverage vending machine, that does not waste space for a holding area for delivery of the product or for product trays that require the tray to be sloping for delivery of the product to the consumer.

### SUMMARY OF THE INVENTION

The present invention provides a method of moving an elevator to a product location in a vending machine to receive product from the product location, including the steps of: providing an indicator associated with each product location; providing a sensor associated with the elevator; moving the sensor first to a position near an expected position of one of the indicators; and searching for an actual position of the indicator. The present invention also provides an apparatus for performing the method.

### BRIEF DESCRIPTION OF THE DRAWINGS

FIG. 1 is a front perspective view of a vending machine tray according to an embodiment of the present invention;

FIG. 2 is an enlarged partial view of the vending machine tray of FIG. 1;

FIG. 3 is a front perspective view of a partially disassembled vending machine tray according to an embodiment of the present invention;

FIG. 4 is a front perspective view of a partially assembled vending machine tray according to an embodiment of the present invention;

FIG. 5 is a front perspective view of two unattached vending machine trays according to an embodiment of the present invention;

FIG. 6 is a front perspective view of two attached vending machine trays according to an embodiment of the present invention;

FIG. 7 is a top view of two attached vending machine trays having product loaded therein according to an embodiment of the present invention;

FIG. 8 is a rear perspective view of a partially assembled vending machine tray according to an embodiment of the present invention;

FIG. 9 is a partial view of an elevator for use with the tray according to an embodiment of the present invention with the product dispenser drive retracted;

FIG. 10 is a partial view of an elevator for use with the tray according to an embodiment of the present invention with the product dispenser drive extended;

FIG. 11 is a front perspective view of a partially assembled vending machine tray with a product present indicator retracted and extended according to an embodiment of the present invention; and

FIGS. 12 and 13 are diagrams of an elevator locating procedure according to an embodiment of the present invention.

### DESCRIPTION OF THE PREFERRED EMBODIMENT

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

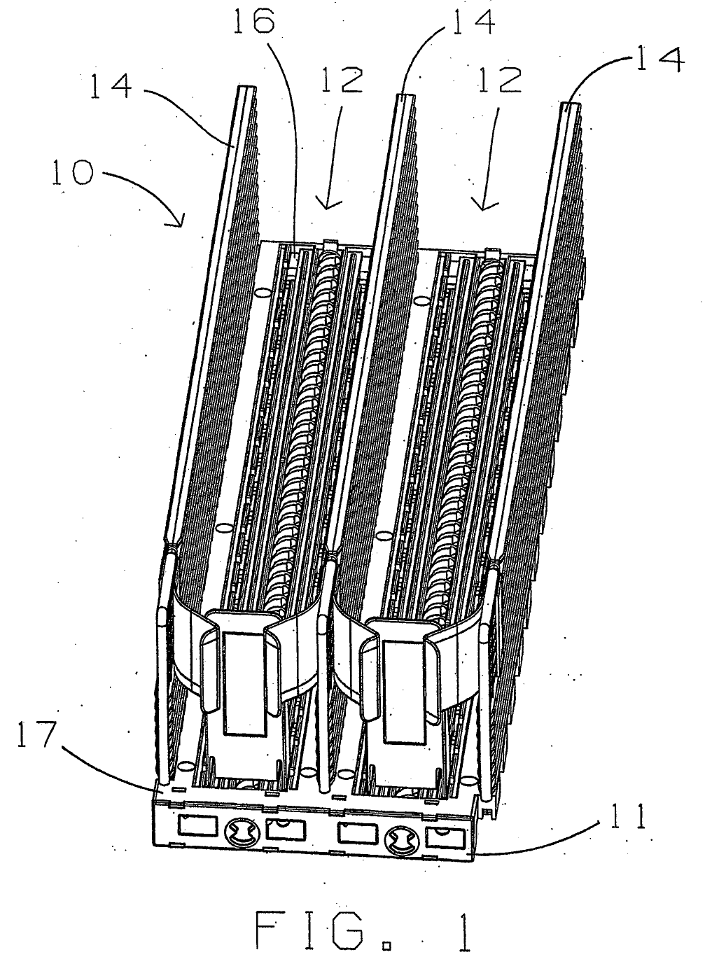

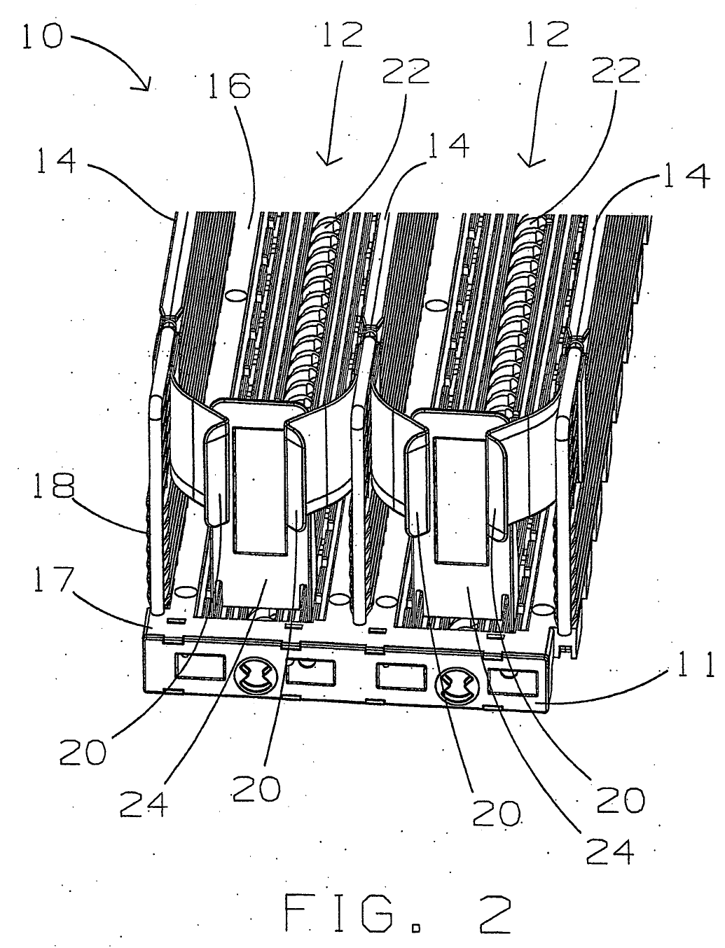

Referring to FIG. 1, the present invention is a vending machine dispenser tray 10. The tray 10 is most suited for vending beverage items such as soda, water, juices, etc. although nothing prevents application of this invention to non-beverage items. The tray 10 has a front 11 and comprises rows 12 that are defined by upstanding walls 14 attached to a base 16 having a front 17. As shown in FIG. 2, at an end 18 of the walls 14 is attached a pair of resilient arms 20. Two resilient arms 20 extend from each wall 14, such that a pair of arms 20 from adjacent walls 14 cooperate to at least partially block the end of each row 12. Located within a channel 13 formed within each row 12 of the base 16 is a threaded shaft 22 that is threaded into a product backstop or drive member 24.

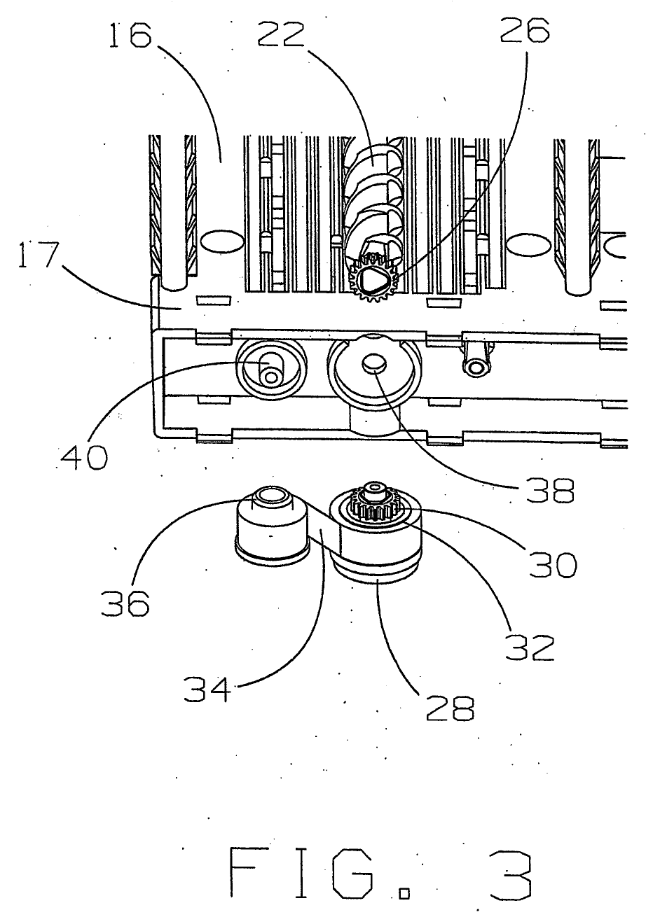

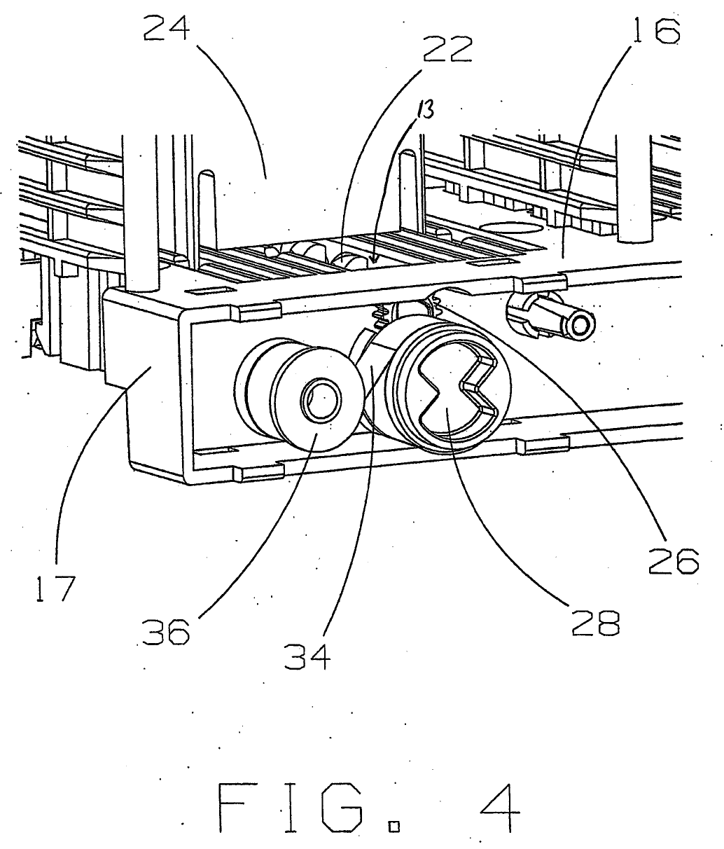

FIGS. 3 and 4 show that each threaded shaft 22 has a gear 26 that is located near the front 17 of the base 16. Each gear 26 is driven by a rotatable drive shaft 28 having a mating gear 30. The drive shaft 28 further defines a smooth outer surface 32. Also provided in the front 17 of the base 16 and adjacent the drive shaft 28 is a linear coil spring 34 wrapped around a rotatable spring shaft 36. An end of the spring 34 is attached to the drive shaft 28, and the other end of the spring 34 is attached to the spring shaft 36. The drive shaft 28 and spring shaft 36 are mounted to the base 16 into a drive shaft hole 38 and onto a spring shaft pin 40, respectively. As the drive shaft 28 is rotated clockwise, the spring 34 is wrapped around the smooth outer surface 32 of the drive shaft 28 and the spring shaft 36 is rotated counterclockwise as the spring 34 uncoils. However, because the spring 34 is wrapped around the drive shaft 28 in the opposite direction to the spring shaft 36, the natural bias of the spring 34 causes the spring 34 to resist being wrapped onto the drive shaft 28. Therefore, the natural bias of the spring 34 urges the drive shaft 28 counterclockwise.

As discussed above, the product drive member 24 is threaded onto the threaded shaft 22. Because the drive shaft 28 is urged counterclockwise, the drive shaft 28 urges the threaded shaft 22 clockwise through the mating gears 26 and 30. The result of the threaded shaft 22 being urged clockwise is that the product drive member 24 is urged to the front 11 of the row 12.

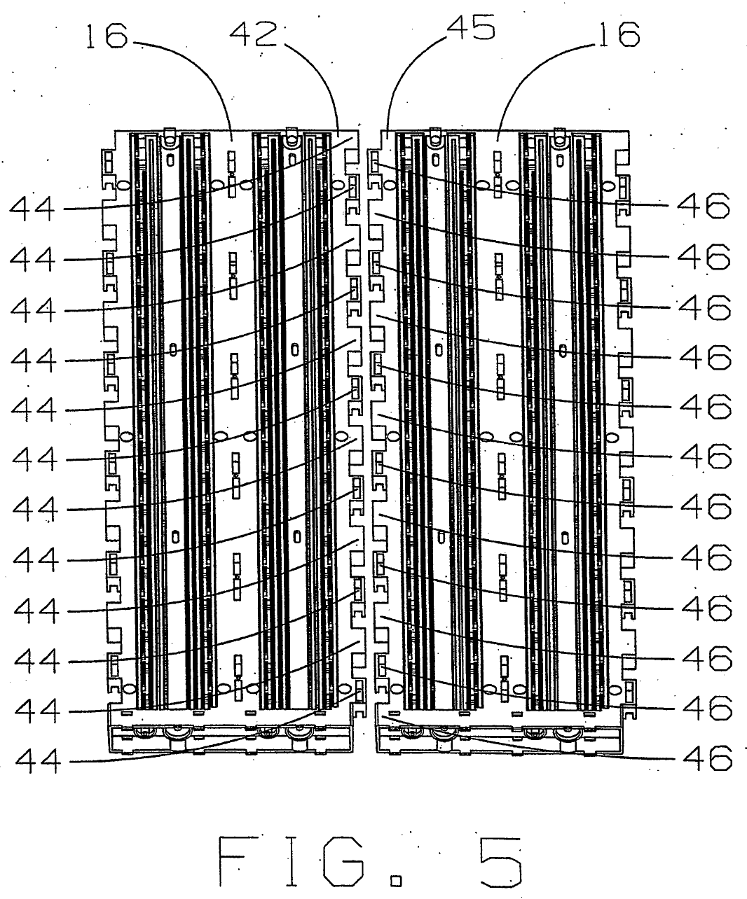

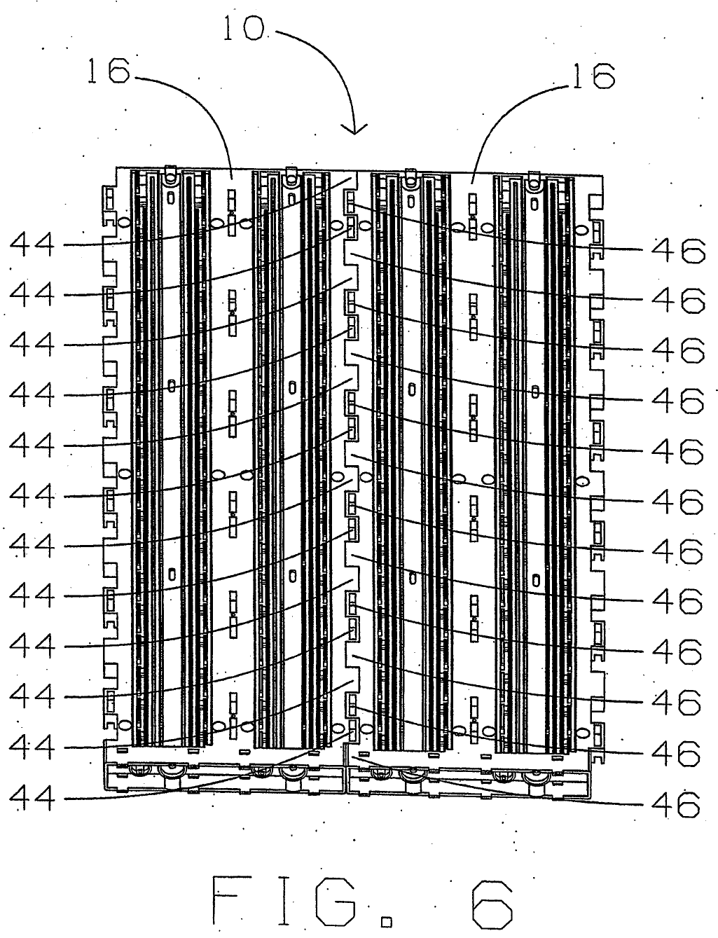

Referring to FIG. 5, the right side 42 of the base 16 defines interlocking fingers 44 and the left side 45 of the base 16 defines interlocking fingers 46. When the left side of a base 16 is brought next to the right side of another base 16 the fingers interlock such that the two bases 16 may be locked together to make a larger tray 10, as shown in FIG. 6.

In the preferred embodiment, the tray is comprised of two rows 12. Therefore, by locking the bases 16 together, a larger tray 10 comprised of any even number of rows 12 can be used within vending machines of various sizes. However, nothing should be construed to limit the invention any particular number of rows and more or fewer rows may be implemented within a tray without departing from the scope of the present invention, for example bases of only a single row that lock together to form a larger tray.

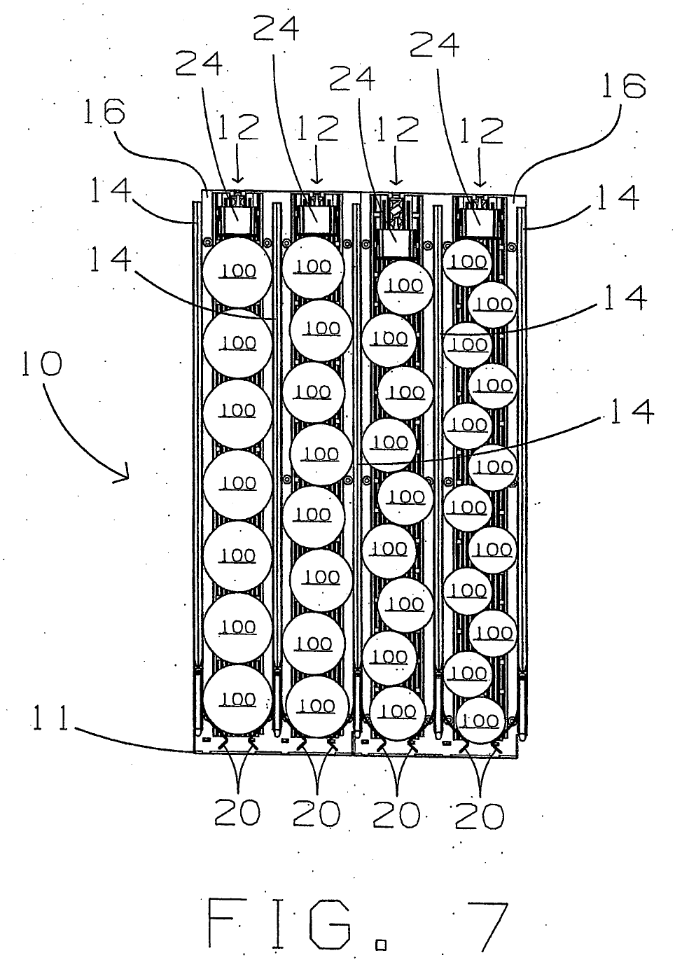

In order to use the device of the present invention, the bases 16 are interlocked together to form a proper width tray 10 suitable for a particular vending machine. Multiple rows of trays are further provided within the vending machine and the rows 12 of the trays 10 are filled with product 100 to be vended, as shown in FIG. 7. The product 100 may be of various sizes as large as the width of the row 12 or as small as slightly larger than half the width of the row 12. To maintain product near the front of the row, the product drive member 24 abuts the rearmost product 100 and the force provided by the spring 34 urges the product 100 within the row 12 against the resilient arms 20 at the front 11 of the tray 10. In this manner the product 100 awaits vending by the machine.

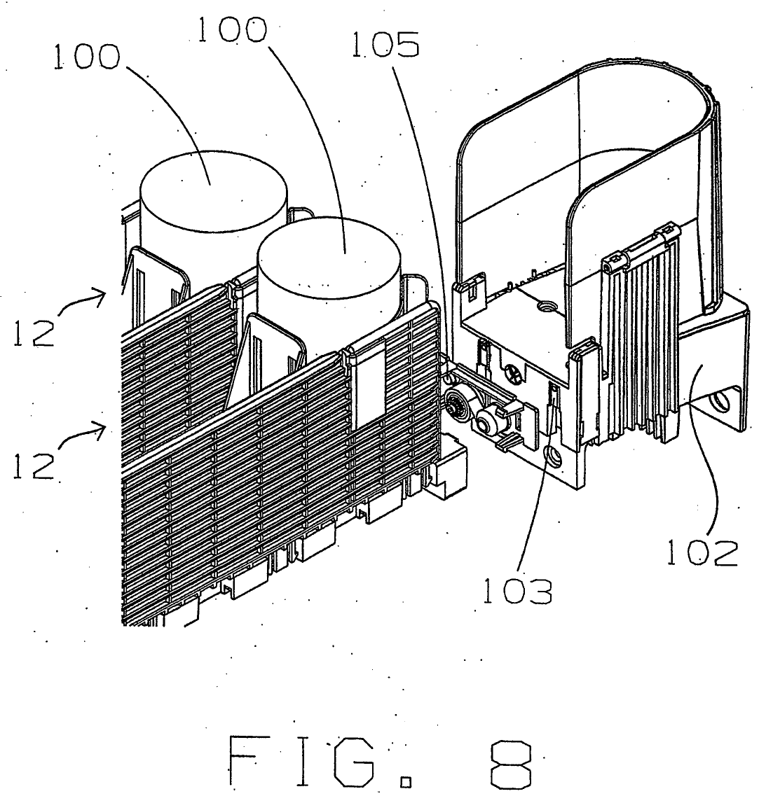

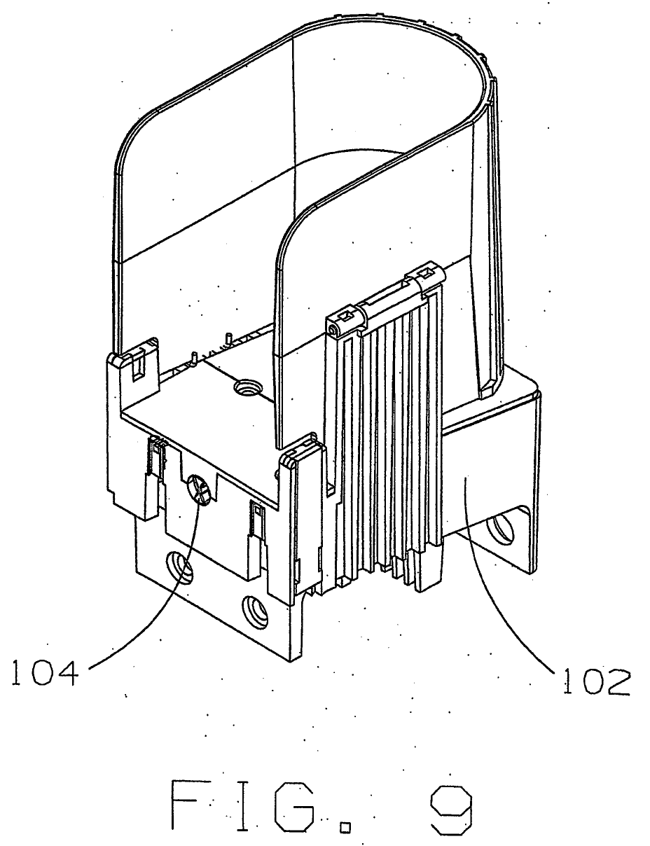

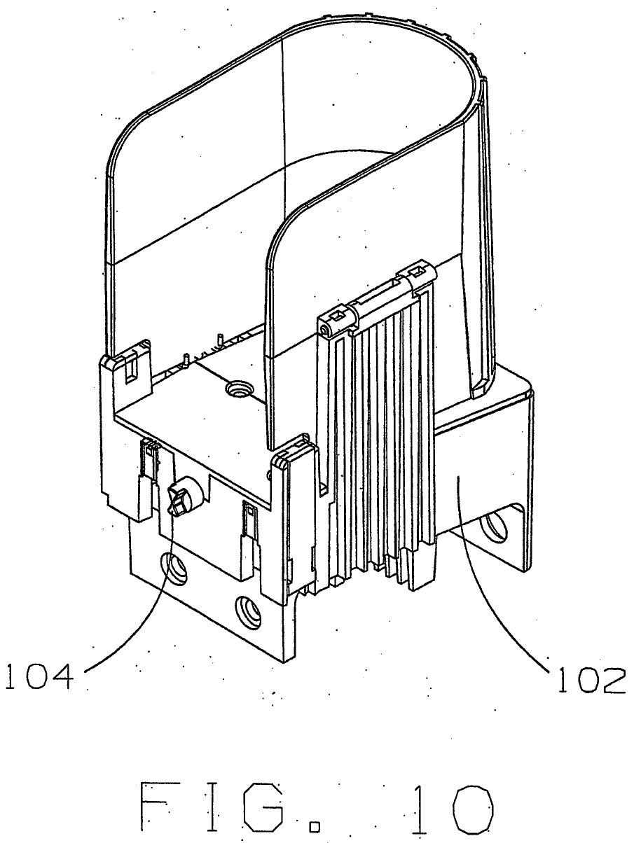

When the time for vending the product 100 arrives, an elevator 102, as shown in FIG. 8, is moved to the desired product row 12 for vending. The elevator 102 comprises a cup for holding the vended product and transporting it to a customer pickup station (not shown). The elevator 102 determines the precise location of the product to be vended by first traveling to an expected location of the row 12 within the vending machine for the product. However, because the vending machine cabinet may have warped due to being placed on uneven ground or merely due to manufacturing tolerances, the expected location may not be the precise location of the row 12 containing the product to be vended. In order to find the precise location, the elevator 102 begins searching in the area of the expected location until a sensor 103 carried by the elevator 102, such as a Hall Effect sensor or a reed switch, locates an indicator 105, such as a magnet, such indicator 105 being located with respect to each row 12 location. Once the elevator has found the indicator associated with the row 12, an electromechanical device (not shown) within the elevator 102 extends a product dispenser drive 104 from a retracted position (FIG. 9) to an extended position (FIG. 10). The product dispenser drive 104 has a cooperating shape to that of the drive shaft 28 and mates with the drive shaft 28 to rotate it. As the drive shaft 28 is rotated by the elevator 102, the product drive member 24 forces product 100 toward the elevator 102 and past the resilient arms 20. Once the product 100 passes the resilient arms 20, it enters the elevator 102 and the product dispenser drive 104 of the elevator 102 stops rotating. The product dispenser drive 104 of the elevator 102 is then retracted and the elevator 102 takes the product 100 for dispensing to a customer.

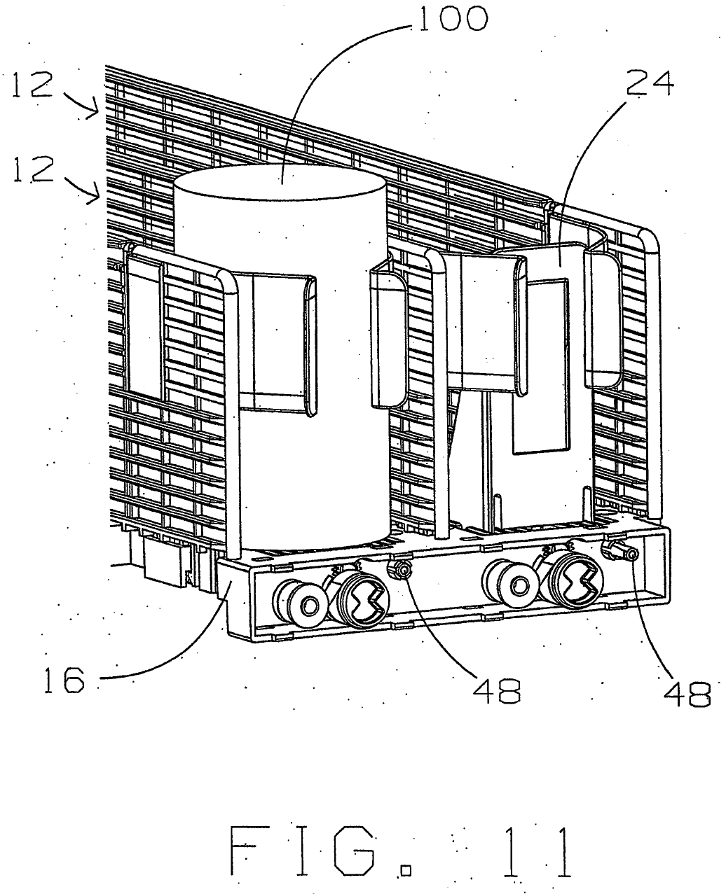

Optionally, a sensor 103 may be provided on the elevator that detects the presence of an indicator 48 with respect to the product drive member 24, as shown in FIG. 11. While product 100 is located within the row 12, the indicator 48 is retracted and not detected by the sensor. In this manner, the vending machine determines that product 100 remains in a particular row. When product 100 no longer is located within the row 12, the indicator 48 is extended and detected by the sensor, and thus detects the absence of product 100 before attempting to vend the product and alerts a consumer to make an alternate product choice.

Alternatively, rather than detecting the presence or absence of product directly, the product elevator 102 can attempt to vend product and if after a predetermined period of time no product 100 is dispensed, the vending machine will determine that no product is present within the row.

When the indicator 105 is a magnet, the system of the present invention finds the precise location of the product to be dispensed (so that the product dispenser drive 104 and the drive shaft 28 properly align) by finding the center of the magnetic field of the magnet to properly locate the elevator 102. The system accomplishes this by first moving to a position of about 0.320″ to the right or left of the expected X/Y coordinates of the selected product. Next, the elevator 102 is moved toward the expected position of the product row. The vending machine records a first position Xa where the sensor 103 first senses the indicator 105. The elevator 102 continues moving past the indicator 105 until the indicator is no longer sensed. The elevator 102 is then driven in the reverse direction and records the position Xb where the position sensor is activated. The vending machine then calculates the center position of X coordinate of the indicator 105 as Xcenter=Xa+(Xa−Xb)/2. Next, the elevator 102 is moved to a position about 0.5″ below the expected Y coordinate of the indicator and to the Xcenter X coordinate. The elevator 102 is then moved upwardly until the sensor detects the indicator and then an additional 0.160″. At this point, the elevator 102 is located in an acceptable position to extend the product dispenser drive 104 and rotate the drive shaft 28 to vend product. Alternatively, the center of the Y coordinate could be determined in the same manner as the X coordinate. In yet a further alternative variation, the X coordinate could be determined by finding leading edge of the indicator 105 and moving a predetermined distance just as with the Y coordinate above.

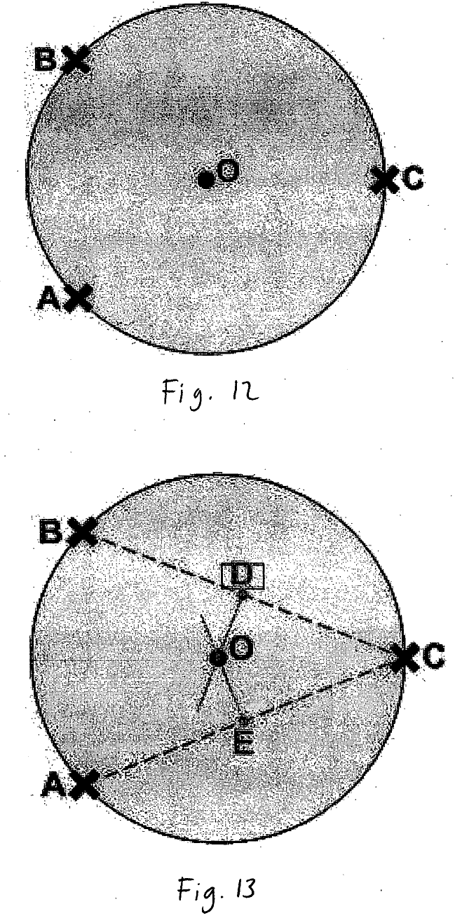

In another method of finding the center of the indicator 105 and referring to FIGS. 12 and 13, the elevator 102 is moved to a position below the indicator (Y coordinate) and to the expected X coordinate of the indicator 105. Next, the elevator 102 is moved vertically across the indicator 105. Position A and position B are determined by detecting the presence or absence of the indicator as the sensor 103 and elevator 102 move past the indicator 105. Understanding that the expected X coordinate of the indicator 105 might not be the actual X coordinate of the indicator, the chord joining position A and position B may not pass through the center of the indicator 105. The elevator 102 now moves to the center point between position A and position B (Y coordinate) and the expected X coordinate of the indicator 105. Next, the elevator 102 moves to the right or left until the presence of the indicator 105 is no longer detected. This position is then recorded as position C. Provided that the indicator is uniform, the three detected positions A, B, and C will represent three points along the circumference of a circle about the indicator 105.

To find the center of the indicator from the three positions detected, the system must find the point of intersection of the perpendicular bisectors of any two chords defined by the three positions. The first step to calculating the center point is to solve the equations for the lines containing segments AC and BC in the form ax+by=c. For each segment, the constants are determined using the following equations
a_{BC}=y_{B}−y_{C}
b_{BC}=x_{C}−x_{B}
a_{AC}=y_{A}−y_{C}
b_{AC}=x_{C}−x_{A}

The next step is to determine the equation for the perpendicular bisector of the lines containing AC and BC. These bisecting lines will contain the line segments EO and DO. The equation of the perpendicular bisector is −bx+ay=d. The constant d is determined by calculating the midpoint of the desired line segment and inserting the value for x and y, as shown below.
d_{DO}=−b_{BC}((x_{B}+x_{C})/2)+a_{BC}((y_{B}+y_{C})/2)
d_{EO}=−b_{AC}((x_{A}+x_{C})/2)+a_{AC}((y_{A}+y_{C})/2)

Now that the perpendicular bisectors have been found, the intersection of these two lines is calculated. The three equations below are used to calculate the position of the center point.
Det=−b_{BC}*a_{AC}+b_{AC}*a_{BC}
x_{O}=(a_{AC}*d_{DO}−a_{BC}*d_{EO})/Det
y_{O}=(−b_{BC}*d_{EO}+b_{AC}*d_{DO})/Det

As long as the two lines AC and BC are not parallel, the center point can be determined. Moreover, the center O can be calculated with any three points on the circle, regardless of their position. Thus, in an alternative embodiment, the system could make diagonal passes across the sensor 105 and still calculate the correct center point.

The preferred means for recording the above positions and calculating the product location is an electric circuit, more preferable an integrated circuit, such as an application specific integrated circuit or ASIC.

In the present invention, the new coordinates for the indicator 105 may be memorized by the vending machine such that, in the future, the elevator will proceed directly to the new position or, as is preferred, the coordinates are not memorized in any manner and they are redetermined with each product vend cycle. By not memorizing the coordinates, the precise coordinates are always detected and mis-vending of product is avoided. This is particularly useful when the dimensions of the vending machine may have changed, for example, as a result of moving the vending machine or changing the vending machine geometry as a result of changing product weight distribution.

While the specific embodiments have been illustrated and described, numerous modifications come to mind without significantly departing from the spirit of the invention.

We claim:

1. A vending machine for vending product comprising:
a cabinet;
a plurality of shelves disposed within the cabinet, each shelf comprising a base upon which product to be vended may be placed, the product being placed in rows along each shelf such that from a front of each shelf the rows of product may be accessed;
an elevator capable of moving within the cabinet to a position adjacent a first item of one of the rows of product;
an indicator associated with each row of product; and
a sensor associated with the elevator;
a circuit adapted to provide a signal for moving the sensor first to a position near an expected position of one of the indicators and the circuit also adapted to then search for an actual position of the indicator by moving the sensor to find the coordinates of the indicator.

2. The vending machine of claim 1 wherein the circuit is adapted to determine the actual position of a center of the indicator by finding points on the periphery of the indicator.

3. The vending machine of claim 1 wherein the circuit is adapted to determine the actual position of a center of the indicator by finding points on the periphery of the indicator by moving the sensor vertically and a horizontally.

4. The vending machine of claim 1 wherein the circuit is adapted to determine the actual position of a center of the indicator by finding points on the periphery of the indicator by moving the sensor diagonally.

5. The vending machine of claim 1 wherein the circuit is adapted to determine the actual position of the indicator by moving the sensor across the indicator in an X direction to find horizontal edges of the indicator, the circuit is adapted to move the sensor in a Y direction to find vertical edges of the indicator and the circuit is adapted to determine coordinates of a center of the indicator by determining the midpoint of a line joining the positions found along the horizontal edges and a midpoint of the line joining the positions found along the vertical edges.

6. The vending machine of claim 1 wherein the circuit is adapted to determine the actual position of the indicator by moving the sensor across the indicator in an X direction to find horizontal edges of the indicator, the circuit is adapted to move the sensor in a Y direction to find another edge of the indicator and the circuit is adapted to determine a position of a center of the indicator by determining the intersection of a first and a second line,
the first line running perpendicularly through the midpoint of a line joining one of the positions found while moving in the X direction and the position found while moving in the Y direction and
the second line running perpendicularly through the midpoint of a line joining the other position found while moving in the X direction and the position found while moving in the Y direction.

7. The vending machine of claim 1 wherein the circuit is adapted to determine the actual position of the indicator by moving the sensor across the indicator in an Y direction to find horizontal edges of the indicator, the circuit is adapted to move the sensor in a X direction to find another edge of the indicator and the circuit is adapted to determine a position of a center of the indicator by determining the intersection of a first and a second line,
the first line running perpendicularly through the midpoint of a line joining one of the positions found while moving in the Y direction and the position found while moving in the X direction and
the second line running perpendicularly through the midpoint of a line joining the other position found while moving in the Y direction and the position found while moving in the X direction.

8. The vending machine of claim 1 further comprising:
a plurality of walls attached to the base separating the rows of product; and
a channel within the flat base for housing a threaded shaft, the threaded shaft threadingly attached to a product drive member.

9. The vending machine of claim 1 further comprising at least one resilient arm attached to the tray and biased in a position that substantially blocks product from exiting a row, the resilient arm being adapted to resiliently deflect when the product drive member forces product past the resilient arm so that the product may be vended and adapted to return to its initial position to block the next product in the row.

10. The vending machine of claim 8 wherein the threaded shaft is drivable by a product dispenser drive associated with the elevator when the elevator is in position to receive product from a shelf.

11. The vending machine of claim 1 wherein the indicator is a magnet.

12. A vending machine for vending product comprising:
a cabinet;
a plurality of shelves disposed within the cabinet, each shelf comprising a base upon which product to be vended may be placed, the product being placed in rows along each shelf such that from a front of each shelf the rows of product may be accessed;
an elevator capable of moving within the cabinet to a position adjacent a first item of one of the rows of product;
an indicator associated with each row of product; and
a sensor associated with the elevator;
means for providing a signal for moving the sensor first to a position near an expected position of one of the indicators and for searching for an actual position of the indicator by moving the sensor to find the coordinates of the indicator.

13. The vending machine of claim 12 wherein the circuit is adapted to determine the actual position of a center of the indicator by finding points on the periphery of the indicator.

14. The vending machine of claim 12 wherein the circuit is adapted to determine the actual position of a center of the indicator by finding points on the periphery of the indicator by moving the sensor vertically and a horizontally.

15. The vending machine of claim 12 wherein the circuit is adapted to determine the actual position of a center of the indicator by finding points on the periphery of the indicator by moving the sensor diagonally.

16. The vending machine of claim 12 wherein the circuit is adapted to determine the actual position of the indicator by moving the sensor across the indicator in an X direction to find horizontal edges of the indicator, the circuit is adapted to move the sensor in a Y direction to find vertical edges of the indicator and the circuit is adapted to determine coordinates of a center of the indicator by determining the midpoint of a line joining the positions found along the horizontal edges and a midpoint of the line joining the positions found along the vertical edges.

17. The vending machine of claim 12 wherein the circuit is adapted to determine the actual position of the indicator by moving the sensor across the indicator in an X direction to find horizontal edges of the indicator, the circuit is adapted to move the sensor in a Y direction to find another edge of the indicator and the circuit is adapted to determine a position of a center of the indicator by determining the intersection of a first and a second line,
the first line running perpendicularly through the midpoint of a line joining one of the positions found while moving in the X direction and the position found while moving in the Y direction and
the second line running perpendicularly through the midpoint of a line joining the other position found while moving in the X direction and the position found while moving in the Y direction.

18. The vending machine of claim 12 wherein the circuit is adapted to determine the actual position of the indicator by moving the sensor across the indicator in an Y direction to find horizontal edges of the indicator, the circuit is adapted to move the sensor in a X direction to find another edge of the indicator and the circuit is adapted to determine a position of a center of the indicator by determining the intersection of a first and a second line,
the first line running perpendicularly through the midpoint of a line joining one of the positions found while moving in the Y direction and the position found while moving in the X direction and
the second line running perpendicularly through the midpoint of a line joining the other position found while moving in the Y direction and the position found while moving in the X direction.

19. A method of moving an elevator to a product location in a vending machine to receive product from the product location, comprising the steps of:
providing an indicator associated with each product location;
providing a sensor associated with the elevator;
moving the sensor first to a position near an expected position of one of the indicators; and
searching for an actual position of the indicator.

20. The method of claim 19 wherein the searching step further comprises the step of moving the sensor to find the actual coordinates of the indicator.

21. The method of claim 19 wherein the searching step further comprises the step of determining the actual position of a center of the indicator by finding points on the periphery of the indicator.

22. The method of claim 19 wherein the searching step further comprises the step of determining the actual position of a center of the indicator by finding points on the periphery of the indicator by moving the sensor vertically and a horizontally.

23. The method of claim 19 wherein the searching step further comprises the step of determining the actual position of a center of the indicator by finding points on the periphery of the indicator by moving the sensor diagonally.

24. The method of claim 19 wherein the searching step further comprises the step of determining the actual position of the indicator by moving the sensor across the indicator in an X direction to find horizontal edges of the indicator, the circuit is adapted to move the sensor in a Y direction to find vertical edges of the indicator and the circuit is adapted to determine coordinates of a center of the indicator by determining the midpoint of a line joining the positions found along the horizontal edges and a midpoint of the line joining the positions found along the vertical edges.

25. The method of claim 19 wherein the searching step further comprises the step of determining the actual position of the indicator by moving the sensor across the indicator in an X direction to find horizontal edges of the indicator, the circuit is adapted to move the sensor in a Y direction to find another edge of the indicator and the circuit is adapted to determine a position of a center of the indicator by determining the intersection of a first and a second line,
the first line running perpendicularly through the midpoint of a line joining one of the positions found while moving in the X direction and the position found while moving in the Y direction and
the second line running perpendicularly through the midpoint of a line joining the other position found while moving in the X direction and the position found while moving in the Y direction.

26. The method of claim 19 wherein the searching step further comprises the step of determining the actual position of the indicator by moving the sensor across the indicator in an Y direction to find horizontal edges of the indicator, the circuit is adapted to move the sensor in a X direction to find another edge of the indicator and the circuit is adapted to determine a position of a center of the indicator by determining the intersection of a first and a second line,
the first line running perpendicularly through the midpoint of a line joining one of the positions found while moving in the Y direction and the position found while moving in the X direction and
the second line running perpendicularly through the midpoint of a line joining the other position found while moving in the Y direction and the position found while moving in the X direction.
